(19) United States
(12) Patent Application Publication
(10) Pub. No.: US 2008/0076016 A1
(43) Pub. Date: Mar. 27, 2008

(54) Design for reducing thermal spreads within a battery module

(76) Inventors: Debashis Ghosh, Williamsville, NY (US); John R. Hambruch, Burt, NY (US)

Correspondence Address: DELPHI TECHNOLOGIES, INC., M/C 480-410-202, PO BOX 5052, TROY, MI, 48007, US

(21) Appl. No.: 11/820,904

(22) Filed: Jun. 21, 2007

Related U.S. Application Data
(60) Provisional application No. 60/846,232, filed on Sep. 21, 2006.

(51) Int. Cl. H01M 10/50

(52) U.S. Cl. 429/120

(57) ABSTRACT

A battery pack assembly comprising a plurality of battery packs each including a plurality of cells and a plurality of blocking pieces. Each battery pack defines an air path therethrough and each of the air paths includes an air inlet chamber extending the length of the respective battery pack for supplying air. Each air path is defined on one side by the cylindrical walls of the cells. Each of the cells has an exposed portion being the portion of the respective cell adjacent and exposed to said air inlet chamber. The blocking pieces are disposed in the air inlet chamber. Each blocking piece extends longitudinally along the length of one of the cells and each blocking piece is associated with one of the cells. Each of the blocking pieces reduces the size of the exposed portion of the respective cell to meter the flow of air around the respective cell.

### BACKGROUND OF THE INVENTION

1. Field of the Invention

The present invention relates to a battery pack assembly for providing electrical power.

2. Description of the Prior Art

It is well known to combine a number of battery packs, each including a number of individual cells, for providing electrical power. Heat is generated as electrical current flows into and out of the cells, which heat can have a significant negative impact on the performance and lifetime of the cells and of the battery pack assembly as a whole, if the heat is not effectively managed. Limiting the temperature difference from cell to cell in a battery pack can be important in maximizing the performance and lifetime of the entire battery pack assembly.

To maintain the battery packs and the cells at a desired temperature, a cooling system is often provided within the battery pack assembly. Conventionally, these cooling systems pass air over and around the battery packs and the cells via an inlet manifold and an outlet manifold. In this type of system, the cooling air absorbs heat as it passes over the cells and loses its capacity to absorb heat as it passes over the cells to create temperatures cooler near the inlet manifold than the warmer temperatures near the outlet manifold.

To convey cooling air over the cells, these types of cooling systems define, in each battery pack, an air path from the inlet manifold, over the cells, and to the outlet manifold. Each of the air paths includes an air inlet chamber extending the length of the respective battery pack. Each air path is defined on one side by the cylindrical walls of the cells. Each of the cells has an exposed portion being the portion of the respective cell adjacent and exposed to the air inlet chamber.

The U.S. Pat. No. 6,569,556 to Zhou et al., discloses a cooling system including an inlet manifold and an outlet manifold that direct an air flow through the cells.

Although the prior art discloses systems that cool cells and within a battery pack assembly by passing cooling air through the assembly, significant temperature differences occur from cell to cell due to the non-uniform nature of the cooling air. These temperature differences are detrimental to the performance and lifetime of the battery pack assembly.

### SUMMARY OF THE INVENTION AND ADVANTAGES

The invention provides for a battery pack assembly of the type mentioned above. The assembly includes at least one blocking piece disposed in the air inlet chamber. Each of the blocking pieces extends along the length of one of the cells and is spaced from the exposed portion of the respective cell. Each of the blocking pieces reduces the size of the exposed portion of the respective cell. In doing so, the flow of air around each cell is metered by the respective blocking piece.

The size of the blocking pieces can be varied from blocking piece to blocking piece. As such, hotter cells will have a smaller blocking piece which will create a larger exposed portion. Cooler cells will have a larger blocking piece which will create a smaller exposed portion.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a fragmentary perspective view of the invention;

FIG. 2 is a perspective view also in cross-section of a pair of battery packs used in the embodiment of FIG. 1;

FIG. 3 is a fragmentary front perspective view also in cross-section of the embodiment of FIG. 1 but showing one battery pack;

FIG. 4 is a fragmentary top view of the rear end of the embodiment of FIG. 1; and

FIG. 5 is a perspective view of the entire assembly including the housing and the inlet and outlet manifolds.

### DETAILED DESCRIPTION OF THE INVENTION

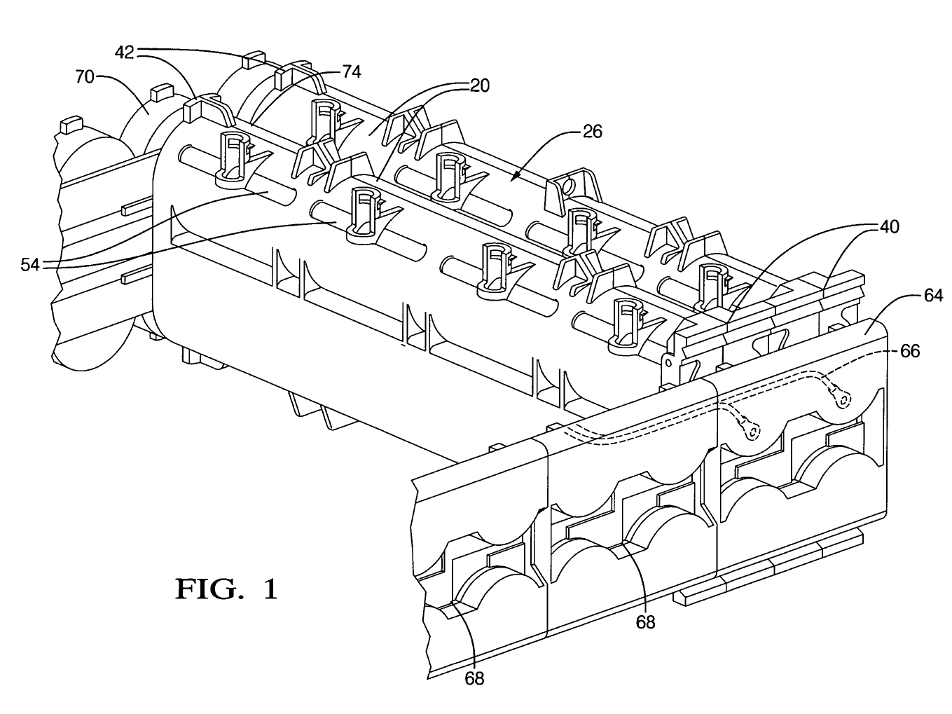

Referring to the Figures, wherein like numerals indicate corresponding parts throughout the several views, a battery pack assembly for providing electrical power is shown, in part, in FIG. 1. The battery pack assembly comprises a plurality of battery packs 20, each generally indicated.

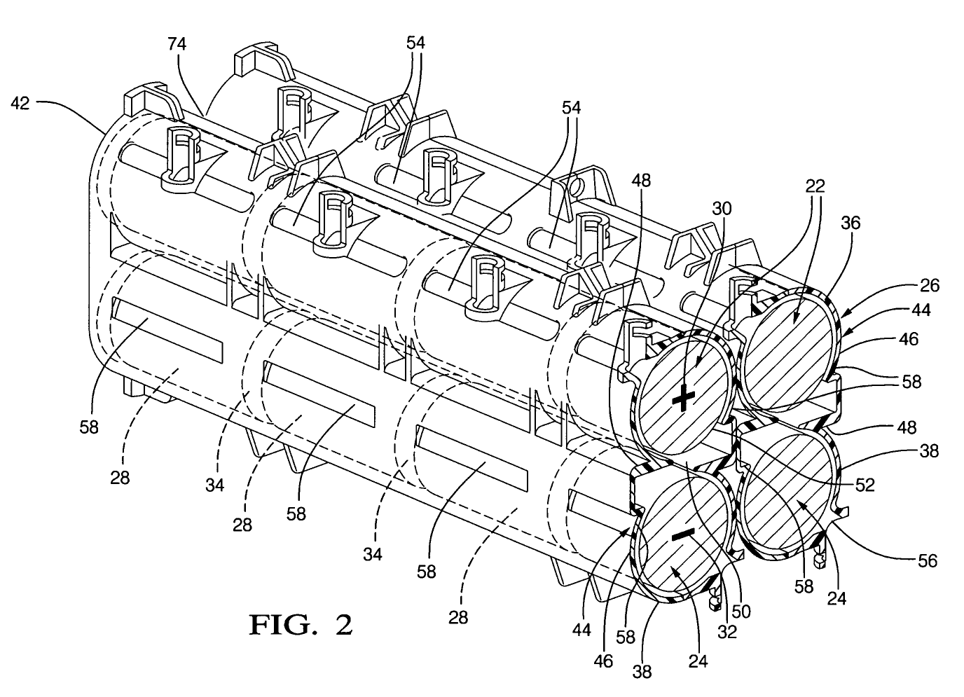

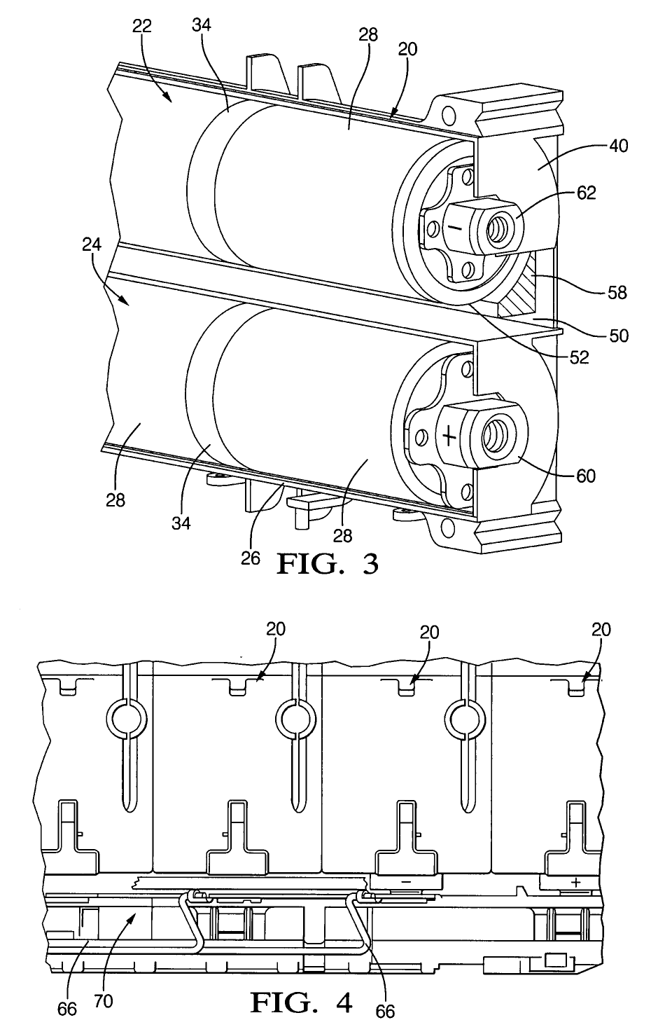

The battery packs 20 are disposed in a side by side relationship, a pair of which are shown in FIG. 2. Each battery pack 20 extends longitudinally and includes an upper stack 22, a lower stack 24, and a casing 26 supporting the stacks 22, 24. All of the stacks 22, 24 are of equal or the same length and extend along parallel and spaced axes. Each stack includes a plurality of cylindrical cells 28 and each cell 28 defines a cylinder and has an anode 30 at one end and a cathode 32 disposed at the opposite end of the cylinder, for storing and conducting electrical power. Alternatively, each stack could include any number of cells 28 and the cells 28 could be a geometric shape other than a cylinder. The cells 28 are arranged in cathode-to-anode relationship with one another along the respective axis, as is well known in the art. The anodes 30 of the cells 28 in the upper stack 22 face in one direction while the anodes 30 of the cells 28 in the lower stack 24 face in the opposite direction, as illustrated in FIG. 3. As such, the cells 28 of each stack are connected to one another in electrical series connection. Additionally, each cell 28 includes a spacer 34 which is cylindrical in shape and wraps around the cell 28 to create a space for air flow between the cells 28 and the casing 26. The spacer 34 is made out of an insulating material such as rubber or plastic.

The casing 26 includes an upper cylindrical section 36 and a lower cylindrical section 38, a front end cover 40, and a back end cover 42. The front end cover 40 is disposed at the front of the battery pack 20 while the back end cover 42 is disposed at the back of the battery pack 20. The end covers 40, 42 enclose the ends of the casings 26. The casing 26 nests the upper stack 22 above the lower stack 24. The upper cylindrical section 36 wraps around a semi-cylindrical portion of the upper stack 22 and extends along the length of the upper stack 22. As illustrated in FIG. 2, the casing 26 also includes a reverse-L-shaped piece 44, generally indicated, to enclose a remainder portion of the upper stack 22. The remainder portion is the portion of the upper stack 22 that is not included in the semi-cylindrical portion. In other words, the remainder portion and the semi-cylindrical portion make up the upper stack 22. The reverse-L-shaped piece 44 includes a long leg 46 that extends vertically and tangentially from the upper cylindrical section 36 adjacent to the right-hand side of the upper stack 22. The reverse-L-shaped piece 44 also includes a short leg 48 that extends transversely to the long leg 46 and connects with the upper cylindrical section 36 adjacent to the bottom side of the upper stack 22. The upper cylindrical section 36 and the reverse-L-shaped piece 44 combine to completely enclose the upper stack 22. More specifically, the upper cylindrical section 36 encloses the semi-cylindrical portion and the reverse-L-shaped piece 44 encloses the remainder portion. The long leg 46 and the short leg 48 define two sides of a reverse-L-shaped air inlet chamber 50. The remaining side of the air inlet chamber 50 is defined by the cylindrical walls of the remainder portion of the upper stack 22. The air inlet chamber 50 supplies air to the space between the upper cylindrical section 36 of the casing 26 and the cells 28. As noted above, the spacers 34 create this space by preventing the casing 26 from contacting the cells 28.

The air inlet chamber 50 is generally right-triangular in cross section. The right-triangular cross section has two legs 46, 48 and a hypotenuse. The long leg 46 and the short leg 48 define the legs 46, 48 of the right-triangular cross section and the cylindrical wall of the remainder portion of the upper stack 22 define the hypotenuse of the right-triangular cross section. The hypotenuse has a slight curvature due to the cylindrical shape of the walls of the cells 28. The air inlet chamber 50 extends along the length of the upper stack 22.

The remainder portion of the upper stack 22 creates an exposed portion 52 on each of the cells 28 that comprise the upper stack 22. The exposed portion 52 is the portion of each cell 28 that is adjacent and directly exposed to the air inlet chamber 50. Further, the exposed portion 52 of each cell 28 is enclosed by and spaced from the reverse-L-shaped piece 44. The semi-cylindrical portion of the upper stack 22 creates a portion on each of the cells 28 of the upper stack 22 that is not directly exposed to the air inlet chamber 50.

The upper cylindrical section 36 of the casing 26 also defines a plurality of upper exits 54 that are axially aligned in the upper cylindrical section 36 diametrically opposite the reverse-L-shaped piece 44. These upper exits 54 discharge cooling air flowing from the air inlet chamber 50 and over the cells 28 of the upper stack 22 via the space created by the spacers 34.

The lower cylindrical section 38 of the casing 26 has a configuration identical to that of the upper cylindrical section 36. The lower cylindrical section 38 is disposed directly below the upper cylindrical section 36 and is rotated one hundred eighty degrees (180°) with respect to the upper cylindrical section 36. In this arrangement, the short leg 48 of the upper reverse-L-shaped piece 44 is tangent to the lower cylindrical section 38 and the short leg 48 of the lower reverse-L-shaped piece 44 is tangent to the upper cylindrical section 36. As such, the reverse-L-shaped air inlet chambers 50 are open to one another and in fluid communication.

The remainder portion of the lower stack 24 creates an exposed portion 52 on each of the cells 28 that comprise the lower stack 24. The semi-cylindrical portion of the lower stack 24 creates a portion on each of the cells 28 of the lower stack 24 that is not directly exposed to the air inlet chamber 50.

Similar to the upper cylindrical section 36, the lower cylindrical section 38 defines a plurality of lower exits 56 that are axially aligned in the lower cylindrical section 38 diametrically opposite the reverse-L-shaped piece 44 and diametrically opposite the upper exits 54 of the upper cylindrical section 36. These lower exits 56 discharge cooling air flowing from the air inlet chamber 50 and over the cells 28 of the lower stack 24 via the space created by the spacers 34.

The air path created by the casing 26 and the spacers 34 flows from the two reverse-L-shaped air inlet chambers 50, along the length of the stacks 22, 24, around the cells 28 via the space created by the spacers 34, and out the exits 54, 56.

A first plurality of blocking pieces 58 is disposed in the air inlet chamber 50. Each blocking piece 58 of the first plurality is associated with one of the cells 28 of the particular battery pack 20. Each of the blocking pieces 58 reduces the size of the exposed portion 52 of the respective cell 28 to meter the flow of air into the respective cylindrical section around the respective cell 28. Without the blocking pieces, the cells 28 at the front of the battery pack 20 that receive the entire stream of cooling air from the air inlet chamber 50 would incur a high rate of heat transfer due to the larger exposed portion 52 of the cell 28. Also, the cells 28 further back in the battery pack 20 would receive only a portion of the stream of cooling air, which portion would be warmer in temperature due to the exposure to the cells 28 at the front of the battery pack 20.

By reducing the size of the exposed portion 52 of the respective cell 28, less cooling air is exposed to the respective cells 28 at the front of the battery pack 20. As such, the air that is not exposed remains cool, i.e., the unexposed air is not heated up by the cells 28 at the front of the battery pack 20. The air that reaches the back of the battery pack 20, is cooler in temperature and can better cool the cells 28 at the back of the battery pack 20. As a result, the warmer cells 28 at the back of the battery pack 20 are cooled more; and the cooler cells at the front of the battery pack 20 are cooled less, hence, the overall temperature difference from cell 28 to cell 28 is minimized.

Each of the blocking pieces 58 extends longitudinally along the length of one of the cells 28. Each of the blocking pieces 58 can additionally extend longitudinally from one spacer 34 to the next successive spacer 34. Each of the blocking pieces 58 is generally right-triangular in cross section. As such, each blocking piece 58 is generally wedge-shaped. Each of the blocking pieces 58 extends inwardly from the respective long leg 46 and toward the respective cell 28. The blocking pieces 58 are hollow and defined by walls. The blocking pieces 58 are molded or formed into the casing 26 and, as such, are integral to the casing 26. The walls of the blocking pieces 58 are the same thickness as the walls of the casing 26; this contributes to ease in molding or forming. Alternatively, the blocking pieces 58 can be separate from the casing 26 and can be attached in place as necessary.

The right-triangular cross section has a hypotenuse that has a slight curvature. The curvature of the hypotenuse of the cross section of each blocking piece 58 is congruent to the curvature of the hypotenuse of the cross section of the air inlet chamber 50. The curvature of the hypotenuse of the right-triangular cross section of the blocking piece 58 defines a curved surface on the blocking piece 58 that extends the length of the blocking piece 58.

Each blocking piece 58 is disposed in the air inlet chamber 50 such that the curved surface of each blocking piece 58 aligns with and is spaced from the cylindrical walls of the exposed portion 52 of the respective cell 28. The spacing allows the cooling air to flow around the cell 28, while not being directly exposed to the air inlet chamber 50. The hypotenuse of the right-triangular cross section of the blocking piece 58 is shorter in length than the hypotenuse of the right-triangular cross section of the air inlet chamber 50. If both were the same length, the entire length of the air inlet chamber 50 would be blocked by the blocking piece 58.

The right triangular cross sections of said blocking pieces 58 can decrease in area from front to back of the cell 28 of the respective blocking piece 58. In other words, each blocking piece 58 can taper from front to back. As such, the respective curved surface can also taper from front to back of the respective blocking piece 58.

The area of each of the curved surfaces can vary in area from blocking piece 58 to blocking piece 58. As such, the shape of each of the blocking pieces 58 varies from blocking piece 58 to blocking piece 58. As the area of the curved surface increases, the exposed portion 52 of the respective cell 28 decreases. Less of the wall of the cell 28 is directly exposed to the air of the air inlet chamber 50 because it is blocked by the blocking piece 58.

Accordingly, the area of the curved surfaces of the blocking pieces 58 decreases from front to back of each battery pack 20. By doing this, the exposed portions 52 of the respective cells 28 increase. The hotter cells 28 at the back of each battery pack 20 receive more cooling air than the cooler cells 28 at the front of the battery pack 20. Also, the air received by the hotter cells 28 at the back of each battery pack 20 is cooler in temperature than it would be without the blocking pieces 58. As a result, the temperature difference from cell 28 to cell 28 and from front to back is minimized.

Alternatively, the area of each of the curved surfaces can vary to adapt to any other particular configuration of cells 28. Also, each of the blocking pieces 58 can extend partially along the length of the respective cell 28, i.e. each blocking piece 58 does not have to extend the entire length of the respective cell 28.

The end covers 40, 42 are generally rectangular in shape. Each of the front end covers 40 defines an entry that aligns with the air inlet chambers 50 for conveying the cooling air through the end cover and into the air inlet chambers 50. The back end covers 42 are solid and prevent cooling air from exiting therethrough. As such, the cooling air is forced over the cells 28 and out the upper and lower exits 54, 56.

As shown in FIG. 3, each of the end covers 40, 42 also includes a positive terminal 60 that aligns with the anode 30 of the outermost the cell 28 of one stack and a negative terminal 62 that aligns with the cathode 32 of the outermost the cell 28 of the other stack. These terminals 60, 62 protrude through their respective end cover and contact the anode 30 or cathode 32 of the respective cell 28 to transmit the electrical power generated by the cells 28 in the stacks 22, 24. To facilitate the loading of the cells 28 into the casings 26, each casing 26 is split longitudinally into two pieces 44, 58 that snap together.

An inlet bus bar 64 is disposed along the front end covers 40 of the battery packs 20 for interconnecting the battery packs 20. The arrangement of the battery packs 20 is such that alternate battery packs 20 having the positive terminal 60 extending from the upper stack 22 are interleaved with battery packs 20 having the positive terminal 60 extending from the lower stack 24. In other words, adjacent battery packs 20 have the reverse terminal configuration. If one battery pack 20 has the positive terminal 60 on the top, the next adjacent battery pack 20 has the positive terminal 60 on the bottom. The inlet bus bar 64 includes a plurality of connection wires 66 for electrically connecting the stacks 22, 24 of one battery pack 20 to one another and the battery packs 20 to one another in series connection. The connection wires 66 of the inlet bus bar 64 connect the positive terminal 60 of one battery pack 20 to the negative terminal 62 of the next adjacent battery pack 20.

The inlet bus bar 64 defines a plurality of openings 68, which openings 68 align with the air inlet chambers 50 for conveying the cooling air through the inlet bus bar 64 and into the air inlet chambers 50. The shape of these openings 68 and the subsequent alignment with the air inlet chambers 50 can vary depending upon the configuration of the battery pack 20 assembly.

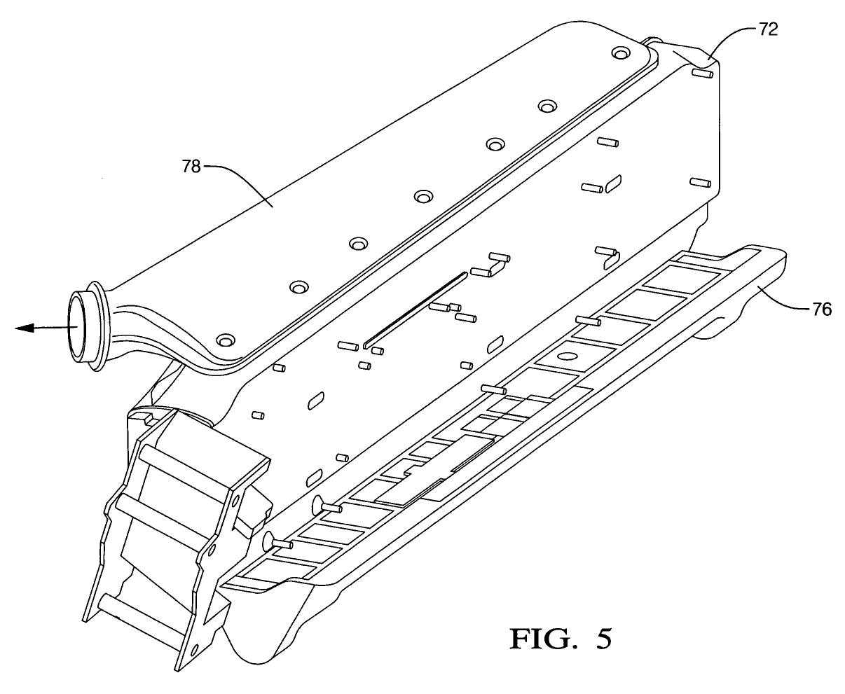

Referring generally to all embodiments, an outlet bus bar 70 is disposed along the back end covers 42 of the battery packs 20 for interconnecting the stacks 22, 24 of each battery pack 20. As is generally indicated in FIG. 4, the outlet bus bar 70 also includes a plurality of connection wires 66. The connection wires 66 of the outlet bus bar 70 connect the positive terminal 60 of one battery pack 20 to the negative terminal 62 of the same battery pack 20. The connections of the inlet bus bar 64 and outlet bus bar 70 combine to connect the all the cells 28 of all the battery packs 20 in series.

The outlet bus bar 70 is solid and prevents air from exiting therethrough. As such, the cooling air is forced over the cells 28 and out the upper and lower exits 54, 56.

A housing 72 encloses the battery packs 20. The side by side relationship of the casings 26 of the battery packs 20 creates V-shaped channels 74 between adjacent upper cylindrical sections 36 and between adjacent lower cylindrical sections 38. The upper or lower cylindrical sections 36, 38 define the walls of the respective channels 74 while the housing 72 defines top or bottom of the channels 74. Each channel 74 extends the length of the battery pack 20. The upper and lower exits 54, 56 defined by the casing 26 discharge cooling air away from the cells 28 and into the channels 74, which convey the air away from the assembly.

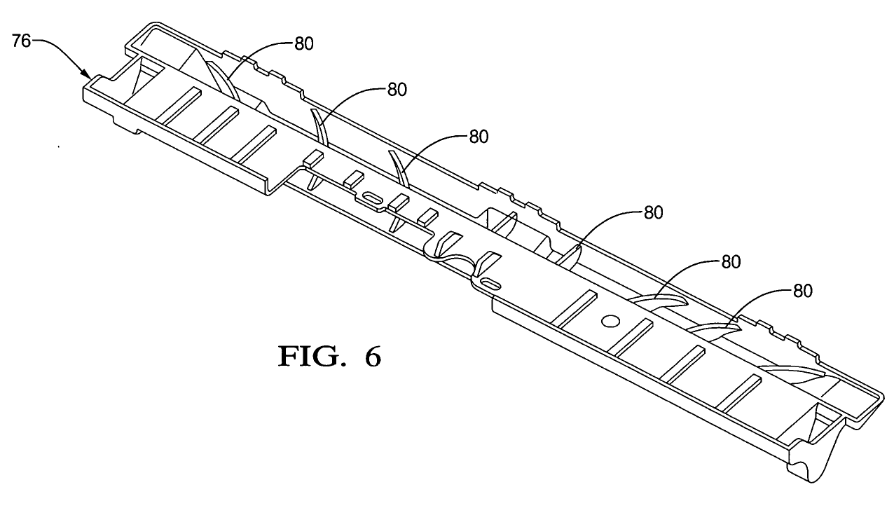

As shown in FIG. 5, an inlet manifold 76 and an outlet manifold 78 are disposed outwardly of the housing 72 along the front and back ends of the battery packs 20, respectively, to establish a flow of cooling air through the assembly. The housing 72 defines a hole through which the inlet manifold 76 supplies cooling air to the system. The housing 72 also defines a hole through which cooling air is conveyed to the outlet manifold 78, which discharges the cooling air from the assembly.

The inlet manifold 76 extends parallel to the inlet bus bar 64 and is spaced from the front end covers 40 of the casing 26. The inlet bus bar 64 is disposed between the inlet manifold 76 and the front end covers 40. The outlet manifold 78 extends parallel to the inlet manifold 76 and along the back end covers 42 of the casing 26. The outlet bus bar 70 is disposed between the outlet manifold 78 and the backs of the battery packs 20.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A battery pack assembly for providing electrical power comprising;
a plurality of battery packs each including a plurality of cells each having an anode and a cathode and a wall being cylindrical for storing and transmitting electrical power disposed in a side by side relationship with each battery pack defining an air path therethrough for cooling,
each of said air paths including an air inlet chamber extending the length of said respective battery pack and being defined on one side by said cylindrical walls of said cells for supplying air to said cells,
each of said cells having an exposed portion being the portion of said respective cell adjacent and exposed to said air inlet chamber, and
at least one blocking piece disposed in said air inlet chamber and extending along the length of one of said cells and spaced from said exposed portion of said respective cell for reducing the size of said exposed portion of said respective cell to meter the flow of air around said respective cell.

2. An assembly as set forth in claim 1 including a first plurality of said blocking pieces with each of said blocking pieces associated with one of said cells of each said battery pack.

3. An assembly as set forth in claim 2 wherein each of said blocking pieces is generally right-triangular in cross section with said right-triangular cross section having a hypotenuse and with said hypotenuse of said right-triangular cross section having a slight curvature.

4. An assembly as set forth in claim 3 wherein said curvature of said hypotenuse of said right-triangular cross section of said blocking piece defines a curved surface extending the length of said blocking piece.

5. An assembly as set forth in claim 4 wherein said each of said battery packs includes a casing for nesting two stacks of said cells one above the other to create an upper stack and a lower stack respectively with each said stack being of equal length and containing equal numbers of said cells.

6. An assembly as set forth in claim 5 wherein each of said cells includes a spacer being made of an insulating material and being cylindrical in shape and wrapping around said cylindrical wall of said cell for creating a space between said cell and said casing longitudinally adjacent said spacer.

7. An assembly as set forth in claim 6 wherein said casing includes an upper cylindrical section circling around a semi-cylindrical portion of said upper stack and extending along the length of said upper stack for creating an enclosed space around said semi-cylindrical portion of said upper stack.

8. An assembly as set forth in claim 7 wherein said casing includes a reverse-L-shaped piece having a long leg extending tangentially from said upper cylindrical section to a short leg extending transversely and spaced from a remainder portion of said upper stack for creating an enclosed space around said remainder portion of said upper stack to define said air inlet chamber for supplying air to said enclosed space around said semi-cylindrical portion between said spacers to cool said cells.

9. An assembly as set forth in claim 8 wherein said air inlet chamber is generally right-triangular in cross section with said right-triangular cross section having two legs and a hypotenuse with said legs of said right-triangular cross section defining said long leg and said short leg and said hypotenuse of said right-triangular cross section having a slight curvature and being defined by said cylindrical walls of said remainder portion of said upper stack.

10. An assembly as set forth in claim 9 wherein said air inlet chamber of said upper cylindrical section extends along the length of said upper stack.

11. An assembly as set forth in claim 10 wherein said remainder portion of said upper stack defines said exposed portion on each of said cells of said upper stack with said exposed portion being the portion of said respective cell adjacent and directly exposed to said air inlet chamber and enclosed by and spaced from said reverse-L-shaped piece.

12. An assembly as set forth in claim 11 wherein said casing includes a lower cylindrical section having an identical configuration to said upper cylindrical section and rotated one hundred eighty degrees from said upper cylindrical section.

13. An assembly as set forth in claim 12 wherein said remainder portion of said lower stack defines said exposed portion of each of said cells of said lower stack with said exposed portion being the portion of said respective cell adjacent and directly exposed to said respective air inlet chamber and enclosed by and space from said respective reverse-L-shaped piece.

14. An assembly as set forth in claim 13 wherein said short leg of said upper reverse-L-shaped piece is tangent to said lower cylindrical section and said short leg of said lower reverse-L-shaped piece is tangent to said upper cylindrical section with said air inlet chambers being open to one another.

15. An assembly as set forth in claim 14 wherein said curvature of said hypotenuse of said right-triangular cross section of said blocking piece is congruent to said curvature of said hypotenuse of said right-triangular cross section of said air inlet chamber.

16. An assembly as set forth in claim 15 wherein said hypotenuse of said right-triangular cross section of said blocking piece is shorter in length than said hypotenuse of said right-triangular cross section of said air inlet chamber.

17. An assembly as set forth in claim 16 wherein each of said curved surfaces of said blocking pieces are aligned with and spaced from said cylindrical walls of said exposed portion of said respective cell.

18. An assembly as set forth in claim 17 wherein each of said blocking pieces extends along the length of said respective cell and longitudinally from one spacer to the next successive spacer.

19. An assembly as set forth in claim 18 wherein said right triangular cross sections of said blocking pieces decrease in area from front to back of said respective blocking piece to define tapered blocking pieces each having a curved surface that tapers from front to back.

20. An assembly as set forth in claim 19 wherein said blocking pieces and said respective curved surfaces vary in area from blocking piece to blocking piece.

21. An assembly as set forth in claim 20 wherein said curved surfaces of said blocking pieces decrease in area from blocking piece to blocking piece and from front to back of said battery pack assembly and said respective exposed portions of said cells increase in area from cell to cell and from front to back of said battery pack assembly.

22. A battery pack assembly for providing electrical power comprising;
a plurality of battery packs each including an upper stack and a lower stack extending parallel to one another and defining an air path therethrough for cooling,
each of said stacks extending along an axis and including a plurality of cylindrical cells disposed end to end and each having walls and defining a cylinder and having a cathode and an anode at opposite ends of said cylinder and being stacked end to end in cathode-to-anode relationship with one another along said axis,
each of said stacks being of equal length and containing equal numbers of said cells,
said anodes of said cells in said upper stack facing in one direction and said anodes of said cells in said lower stack facing in the opposite direction,
each of said battery packs including a casing having a front and a back for nesting said stacks one above the other and two end covers generally rectangular in shape with rounded corners with one of said end covers being disposed on said front and the other of said end caps being disposed on said back,
each of said cells including a spacer being made of an insulating material and being cylindrical in shape and wrapping around said cylindrical wall of said cell adjacent to said anode end of said cell for creating a space between said cell and said casing longitudinally adjacent said spacer,
said casing including an upper cylindrical section circling around a semi-cylindrical portion of said upper stack and extending along the length of said upper stack for creating an enclosed space around said semi-cylindrical portion of said upper stack,
said casing including a reverse-L-shaped piece having a long leg extending tangentially from said cylindrical section to a short leg extending transversely and spaced from a remainder portion of said upper stack for creating an enclosed space around said remainder portion of said upper stack to define an air inlet chamber for supplying air to said enclosed space around said semi-cylindrical portion between said spacers to cool said cells,
said upper cylindrical section and said reverse-L-shaped piece combining to completely enclose said upper stack with said upper cylindrical section enclosing said semi-cylindrical portion and said reverse-L-shaped piece enclosing said remainder portion,
said air inlet chamber being defined by said long leg and said short leg and said cylindrical walls of said remainder portion of said upper stack,
said air inlet chamber being generally right-triangular in cross section with said right-triangular cross section having two legs and a hypotenuse with said legs of said right-triangular cross section defined by said long leg and said short leg and said hypotenuse of said right-triangular cross section having a slight curvature and being defined by said cylindrical walls of said remainder portion of said upper stack,
said air inlet chamber of said upper cylindrical section extending along the length of said upper stack,
said remainder portion of said upper stack creating an exposed portion on each of said cells of said upper stack with said exposed portion of each of said cells being the portion of each cell adjacent and directly exposed to said air inlet chamber and enclosed by and spaced from said reverse-L-shaped piece,
said upper cylindrical section defining a plurality of upper exits axially aligned in said cylindrical section of said casing diametrically opposite to said reverse-L-shaped for discharging air away from said space around said cells,
said casing having a lower cylindrical section having an identical configuration to said upper cylindrical section and rotated one hundred eighty degrees from said upper cylindrical section,
said remainder portion of said lower stack creating an exposed portion on each of said cells of said lower stack with said exposed portion of each of said cells being the portion of each cell adjacent and directly exposed to said air inlet chamber and enclosed by and spaced from said reverse-L-shaped piece,
said short leg of said upper reverse-L-shaped piece being tangent to said lower cylindrical section and said short leg of said lower reverse-L-shaped piece being tangent to said upper cylindrical section with said air inlet chambers being open to one another,
said lower cylindrical section defining a plurality of lower exits axially aligned in said cylindrical section of said casing diametrically opposite to said reverse-L-shaped piece thereof and opposite to said exits in said upper cylindrical section for discharging air away from said space around said cells in said lower cylindrical section,
said air inlet chambers of said lower cylindrical section being engaged with a portion of each of said cells in said lower stack,
each of said end covers including a positive terminal aligning with said anode of the outermost said cell of one stack and protruding through said end cover for contacting said anode and a negative terminal aligning with said cathode of the outermost said cell of the other stack and protruding through said end cover for contacting said cathode to transmit power from said respective stack of said cells,
each said end covers disposed on said front end defining an entry for conveying air through said end cover and into said casing,
a housing enclosing a plurality of said casings of said battery packs in a side by side relationship creating a channel being V-shaped between adjacent cylindrical sections of said casings and extending the length of said battery packs for conveying the air exiting said exits,
an inlet manifold attached to said housing for supplying air to said air inlet chambers and over said battery packs,
an outlet manifold attached to said housing for receiving air from said channels to discharge air from said exits,
said inlet manifold extending along said front end covers of said battery packs and in spaced relationship to said front end covers of said battery packs,
alternate battery packs having said positive terminal extending from said upper stack with the interleaved battery packs having said positive terminal extending from said lower stack,
an inlet bus bar being sandwiched between said inlet manifold and said housing and including a plurality of connection wires for electrically connecting said positive terminal at one end of said battery pack to said negative terminal of the next adjacent battery pack for connecting said battery packs in series,
an outlet bus bar being sandwiched between said outlet manifold and said housing and including a plurality of connection wires for electrically connecting said positive terminal to said negative terminal of each respective battery pack at the other end of said battery pack to complete the series connection of all said battery packs,
said inlet bus bar defining a plurality of openings with each opening to two of said battery packs for conveying air through said inlet bus bar from said inlet manifold to said air inlet chambers of two adjacent battery packs,
said openings each defined by a pair of semi-circular peripheries protruding downwardly and a pair of semi-circular peripheries protruding upwardly to cover said cylindrical sections,
a first plurality of blocking pieces disposed in said air inlet chamber with each of said blocking pieces associated with one of said cells for reducing the size of said exposed portion of said respective cell to meter the flow of air into said respective cylindrical section around said respective cell,
each of said blocking pieces extending longitudinally along the length of one of said cells and longitudinally from one spacer to the next successive spacer and being generally right-triangular in cross section with said right-triangular cross section having a hypotenuse and with said hypotenuse of said right-triangular cross section having a slight curvature,
said curvature of said hypotenuse of said right-triangular cross section of said blocking piece defining a curved surface extending the length of said blocking piece,
said curvature of said hypotenuse of said right-triangular cross section of said blocking piece being congruent to said curvature of said hypotenuse of said right-triangular cross section of said air inlet chamber,
said hypotenuse of said right-triangular cross section of said blocking piece being shorter in length than said hypotenuse of said right-triangular cross section of said air inlet chamber,
each of said curved surfaces of said blocking pieces being aligned with and spaced from said cylindrical walls of said exposed portion of said respective cell,
each of said blocking pieces extending along the length of said respective cell and longitudinally from one spacer to the next successive spacer, and
each of said curved surfaces of said blocking pieces decreasing in area from blocking piece to blocking piece and from front to back of said battery pack assembly and said respective exposed portions of said cells increasing in area from cell to cell and from front to back of said battery pack assembly.
